(19) United States
(12) Patent Application Publication
(10) Pub. No.: US 2009/0185742 A1
(43) Pub. Date: Jul. 23, 2009

(54) METHOD FOR IMAGE COMPENSATION

(75) Inventors: Shih-Chieh Lu, Hsinchu City (TW); Ching-Hsiang Hsu, Taipei City (TW); Ling-Chih Lu, Hsinchu County (TW)

Correspondence Address: J C PATENTS, INC., 4 VENTURE, SUITE 250, IRVINE, CA, 92618, US

(73) Assignee: FARADAY TECHNOLOGY CORP., Hsinchu (TW)

(21) Appl. No.: 12/015,908

(22) Filed: Jan. 17, 2008

(51) Int. Cl. G06K 9/40; G06K 9/36

(52) U.S. Cl. 382/162; 382/266

(57) ABSTRACT

In an image compensation method, formats of images are identified based on ambient color quantity information. If the image is in text format or of high contrast, over compensation is barred to avoid edge effect. A compensation coefficient is set basing on edge eigenvalue of images. The compensation value is fine tuned based on a threshold value to obtain finer compensation result.

### BACKGROUND OF THE INVENTION

1. Field of Invention

The present invention relates to a method for image compensation, and more specifically, relates to an image compensation method in accordance to image characteristics.

2. Description of Related Art

Flat-panel TVs, such as LCD TV, has gradually been a mainstream in the market due to its advantages such as small size, low radiation and etc. In order to make the displayed image more pleasing, image compensation technology is necessary. Image compensation technology includes: spatial compensation and timing compensation.

Spatial compensation technology for example includes: mapping method, ranking method and mask convolution algorithm and etc. Mask convolution algorithm includes: image sharpening process and image unsharpening process. In mask convolution algorithm, mask convolution calculation is performed on images to obtain contour characteristics of the images.

However, in image processing, in the case of over compensation or under compensation, flaws, such as artificiality flaws and edge effect, may likely occur in the processed image. At present, there are a plurality of improvement method, such as U.S. Pat. No. 6,614,944 and Taiwan Patent No. 248759 and etc.

In U.S. Pat. No. 6,614,944, upper threshold values and lower threshold values are calculated in accordance with eigenvalues of image pixels, and upper threshold values and lower threshold values are used to control image compensation coefficient. In Taiwan Patent No. 248759, interpolation operations are based on ambient data to undertake image processing (such as error correction, smoothing, edge strengthening, etc.).

However, in display of text images or high contrast images, if over compensation is applied, double edges may occur. At present, prior arts can't solve such issue.

Therefore, it would be better to have a spatial image compensation method to avoid over compensation and to avoid double edges according to the characteristics of text images. In addition, the spatial image compensation method together with timing image compensation method can address the problem of blurry motion image more effectively.

### SUMMARY OF THE INVENTION

The present invention provides an image spatial compensation method, which can identify format of an image. If the image is in text or high-contrast, over compensation is avoided to prevent occurrence of edge effect.

The present invention provides an image spatial compensation method, by which compensation coefficient can be fine-tuned through threshold value setting, so that compensation result is good.

The present invention provides an image spatial compensation method, which carries out appropriate compensation according to the characteristics of images to avoid side effect after compensation.

An embodiment of the present invention provides an image spatial compensation method, including: receiving an image data, the image data having a plurality of pixel data; capturing an ambient data adjacent to one of the pixel data; determining whether the one of the pixel data is in text format according to the ambient data; and if in text format, determining how to carry out an over compensation to the one of the pixel data according to the determination result, to avoid edge effect.

Another example of the present invention provides an image spatial compensation method, including: (a). receiving an image data, the image data having a plurality of pixel data; (b). capturing an ambient color quantity data adjacent to one of the pixel data; (c). determining whether the one of the pixel data being in text format according to the ambient color quantity data; (d). if not in text format, calculating an edge eigenvalue of the one of the pixel data; (e). setting a compensation coefficient according to the edge eigenvalue; and (f). determining whether the compensation coefficient being greater than a threshold value, so as to determine how to perform compensation to the one of the pixel data.

Yet another example of the present invention provides an image compensation method, including: (a). receiving an image data, the image data having a plurality of consecutive frames and each frame having a plurality of pixel data; (b). comparing gray-scale values of the pixel data of the consecutive frames of the image data to determine whether to perform image spatial compensation and image timing compensation on the image data; (c). if determination to perform image spatial compensation: (c1). determining whether one of the pixel data being in text format according to an ambient color quantity data adjacent to the one of the pixel data; (c2). if in text format, performing no image spatial compensation; and (c3). if not in text format, determining how to perform image spatial compensation to the one of the pixel data according to a threshold value and an edge eigenvalue of the one of the pixel data; and (d). performing timing compensation on the pixel data.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically shows a flow chart of a spatial image compensation method according to a first embodiment of the present invention.

FIG. 2 schematically shows a flow chart of timing and spatial image compensation methods according to a second embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

In an embodiment of the present invention, an image spatial compensation method is provided. Whether an image is in text format is determined base on ambient data of the image. If the image is in text format or of high-contrast, over compensation is avoided to avoid occurrence of double edges. For example setting of a threshold value may be helpful to avoid over compensation.

In another embodiment of the present invention, an image spatial and timing compensation method is provided, so as to effectively solve motion image blurry problem. Wherein, image spatial compensation method may be similar to the previous embodiment. While image timing compensation method for example is not limited to overdrive technology.

### First Embodiment

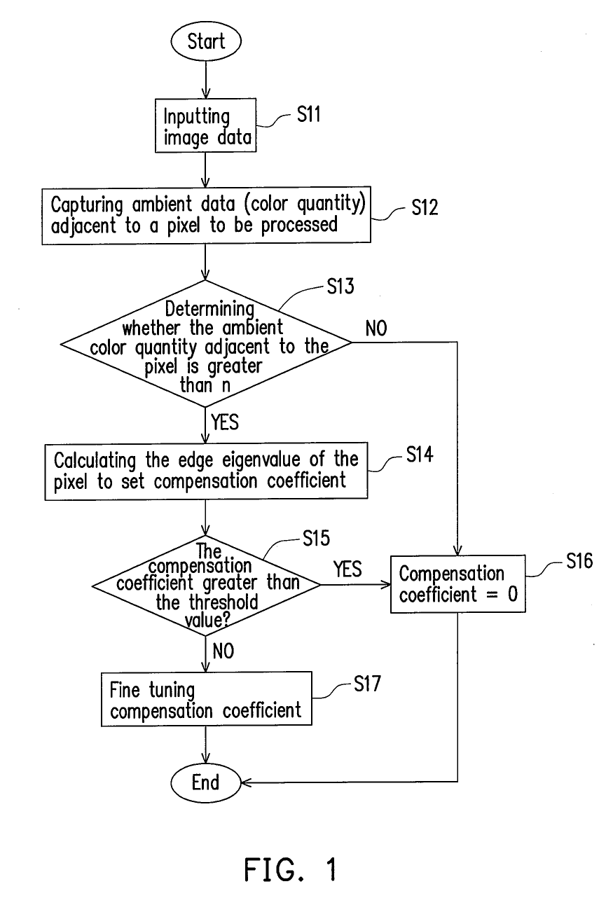

With reference to FIG. 1, FIG. 1 schematically shows a flow chart of an image spatial compensation method according to a first embodiment of the present invention. As shown in FIG. 1, in Step S11, image data is input. The image data includes a plurality of pixels.

In Step S12, ambient data (for example ambient color quantity of the pixel) of a pixel to be processed is captured. For example, as for an 8-bit digital image, the related color gamut may include up to 2⁸*2⁸*2⁸=2²⁴ colors, wherein a color corresponds to a gray-scale value. Therefore, if there are 8 different colors (i.e. 8 different gray-scale values) around the pixel to be processed, then the ambient color quantify of the pixel is 8.

In Step S13, it is determined whether the ambient color quantity of the pixel to be processed is greater than a predetermined value n. “n” is a positive integer, for example, but not limited to 3 or 4. If the ambient color quantity of the pixel is less or equal to n, this indicates that the pixel is in text format. On the contrary, if the ambient color quantity of the pixel is greater than n, then this indicates that the pixel is of non-text colorful image. In Step S13, mask calculation may be used to calculate the ambient color quantity of the pixel. The larger the mask, the more accurate the calculation result; and vice versa.

For example, a photograph taken outdoor is usually of non-text image and may include a very large number of colors, i.e. the ambient color quantity of a pixel is very high.

Generally speaking, the color quantity of text image usually includes background color and font color. In other words, the color quantity included in text image is less, usually only 2˜4 colors. If the text image is of art words with gradient effect, then the text image may include a bit more (but not too many) color quantity. Therefore in the present embodiment, the setting of “n” value may be slightly modified according to formats of text image, however n is not large. In addition, such text format image may not necessarily be still image, i.e. the text format image may be motion image. For example, in TV news program, text banners, scrolling banners or tickers shown on the screen of TV are kind of motion text images.

If it is determined in Step S13 that such image is of text format, the flow connects to Step S16. On the contrary, if it is determined in Step S13 that such image is not of text format, the flow connects to Step S14.

In Step S14, the edge eigenvalue of the pixel is calculated. For example, two-dimensional Laplace algorithm or Gaussian algorithm and the alike may be used to calculate the edge eigenvalue of the pixel. Of course the present embodiment is not limited by the algorithms.

In Step S15, whether the compensation coefficient of the pixel is greater than the threshold value is determined. In the present embodiment, the compensation coefficient relates to the edge eigenvalue calculated in Step S14. If the compensation coefficient is greater than the threshold value, indicating that the pixel has high contrast, then it is not suitable to compensate the pixel having high contrast. Since if compensation is performed to high-contrast image, then double edge problem may likely occur. In addition, generally the edge of high-contrast image is clear, no compensation is needed. On the contrary, the determination that the compensation coefficient is not greater than the threshold value indicates that the image needs to be compensated. If the determined result of Step S15 is YES, then the flow jumps to Step S16; otherwise, the flow jumps to Step S17.

In Step S16, the compensation coefficient is set to 0, i.e. no compensation is applied. The situations of no compensation are: (1) the pixel to be processed is in text format; (2) the pixel to be processed is of high-contrast.

In Step S17, the compensation coefficient is fine tuned to make the compensation result finer. The method for fine tuning the compensation coefficient is, for example but not limited to, multiplying the compensation coefficient by non-integer coefficients. Moreover, the compensation coefficient may also be fine tuned progressively. Spatial image compensation is performed to the pixel to be processed according to the fine-tuned compensation coefficient.

Through Step S14, S15 and S17, after compensation, image edges can be changed from the original blurry state into a clear state. As for the image edge that originally is relatively clear, no compensation is needed, so as to avoid double edge due to over compensation (i.e. Step S16).

### The Second Embodiment

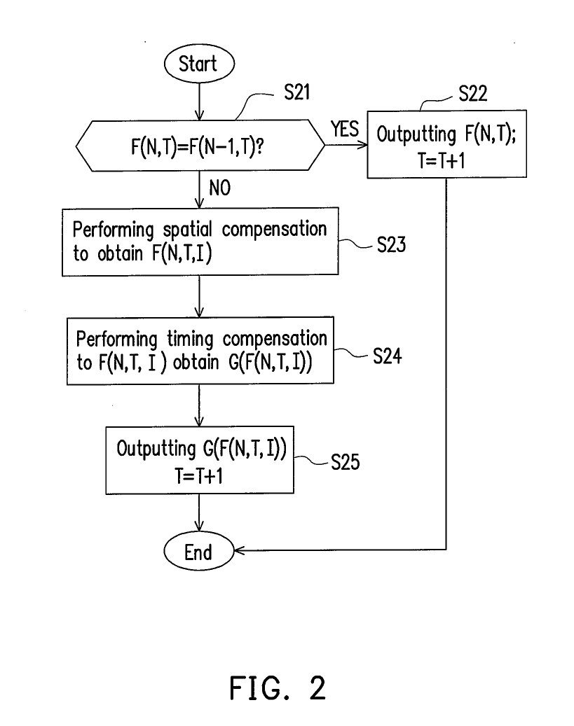

With reference to FIG. 2, FIG. 2 schematically shows a flow chart of a timing and spatial image compensation method according to a second embodiment of the present invention. In the present embodiment, image data is a consecutive data. That is, the image data includes a plurality of consecutive image frames, and the respective image frames includes a plurality of pixels.

As shown in Step S21, it is compared to see whether F(N, T) equals to F(N−1, T). F(N, T) stands for the gray-scale value of the Tₜₕ pixel of the Nₜₕ image frame; and F(N−1, T) stands for the gray-scale value of the Tₜₕ pixel of the previous image frame (i.e. the N−1ₜₕ image frame). Therefore, in the present embodiment, the gray-scale value F(N−1, T) of the Tₜₕ pixel of the previous image frame has to be stored. To further reduce cost, Most Significant Bits (MSB) of F (N, T) and the MSB of F(N−1, T) are stored only. Thus Step S21 is to compare the MSB of F (N, T) and the MSB of F (N−1, T).

In the second embodiment, if the pixel is spatially compensated, then the pixel is also timing compensated. On the contrary, if no spatial compensation is performed to the pixel, then timing compensation is not needed to be performed to the pixel.

If F(N, T) equals to F(N−1, T) (or the MSB of F (N, T) equals to the MSB of F(N−1, T)), it means that the gray-scale values of the Tₜₕ pixel of the two consecutive image frames virtually have no change. In such case, timing and spatial compensations to the pixel are not needed. Therefore, when the comparison result of Step S21 is YES, then the flow jumps to Step S22. As shown in Step S22, F(N, T) is output, and the T value is added by 1 (indicating that next pixel is to be processed).

On the contrary, if F(N, T) is not equal to F(N−1, T) (or the MSB of F (N, T) is not equal to the MSB of F (N−1, T)), it indicates that the gray-scale values of the Tₜₕ pixel of the two consecutive image frames change. In such case, timing and spatial compensations to the pixel are needed. Therefore, when the comparison result of Step S21 is NO, the flow jumps to Step S23.

As shown in Step S23, spatial compensation is performed to F(N, T) to obtain F(N, T, I). Herein, F(N, T, I) stands for the result obtained after spatial compensation is performed to F(N, T). In the second embodiment, spatial compensation may be the same as or similar to the spatial compensation method in the first embodiment, therefore the detailed thereof will no be repeated herein.

Next, as shown in Step S24, a timing compensation is applied on F(N, T, I) to obtain G(F(N, T, I)). Herein, G(F(N, T, I)) stands for the result obtained after timing compensation is applied to F(N, T, I). Timing compensation method is, for example but not limited to, an overdrive technology.

Lastly, G(F(N, T, I)) is output and “T” is updated (T=T+1), as shown in Step S25.

It is understood by those skilled in the arts, in FIG. 2, the step of updating “T” is not necessarily in Step S25. Alternatively, the updating step may be performed in the comparison step (S21).

In the second embodiment, an overdrive technology (i.e. timing compensation) can speed up liquid crystal transition to increase image contrast. In addition, the spatial compensation and the timing compensation can effectively solve the blurry edge problem of motion images.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An image spatial compensation method, comprising:
receiving an image data, the image data having a plurality of pixel data;
capturing an ambient data adjacent to one of the pixel data;
determining whether the one of the pixel data is in text format according to the ambient data; and
if in text format, determining how to carry out an over compensation to the one of the pixel data according to the determination result, to avoid edge effect.

2. The image spatial compensation method of claim 1, wherein the step of capturing the ambient data comprises:
capturing an ambient color quantity adjacent to the one of the pixel data.

3. The image spatial compensation method of claim 2, wherein the step of determining whether the one of the pixel data is in text format comprises:
determining whether the ambient color quantity being greater than a preset value.

4. The image spatial compensation method of claim 3, wherein the step of over compensation comprises:
if in text format, applying no compensation to the one of the pixel data.

5. The image spatial compensation method of claim 1, further comprising:
if not in text format, calculating an edge eigenvalue of the one of the pixel data; and
setting a compensation coefficient according to the edge eigenvalue.

6. The image spatial compensation method of claim 5, further comprising:
determining whether the compensation coefficient being greater than a threshold value.

7. The image spatial compensation method of claim 6, further comprising:
if the compensation coefficient being greater than the threshold value, applying no compensation to the one of the pixel data to avoid edge effect.

8. The image spatial compensation method of claim 6, further comprising:
if the compensation coefficient being not greater than the threshold value, fine tuning the compensation coefficient; and
performing compensation to the one of the pixel data according to the fine-tuned compensation coefficient.

9. An image spatial compensation method, comprising:
(a). receiving an image data, the image data having a plurality of pixel data;
(b). capturing an ambient color quantity data adjacent to one of the pixel data;
(c). determining whether the one of the pixel data being in text format according to the ambient color quantity data;
(d). if not in text format, calculating an edge eigenvalue of the one of the pixel data;
(e). setting a compensation coefficient according to the edge eigenvalue; and
(f). determining whether the compensation coefficient being greater than a threshold value, so as to determine how to perform compensation to the one of the pixel data.

10. The image spatial compensation method of claim 9, wherein the step (f) further comprises:
(f1). if the compensation coefficient being greater than the threshold value, applying no compensation to the one of the pixel data to avoid edge effect; and
(f2). if the compensation coefficient being not greater than the threshold value, fine tuning the compensation coefficient; and performing compensation to the one of the pixel data according to the fine-tuned compensation coefficient.

11. The image spatial compensation method of claim 9, further comprising:
(g). if in text format, determining how to perform over compensation to the one of the pixel data according to the determination result to avoid edge effect.

12. The image spatial compensation method of claim 11, wherein the step (g) comprises:
determining the one of the pixel data as being in text format if the ambient color quantity data being not greater than a preset value.

13. The image spatial compensation method of claim 11, wherein the step (g) comprises:
if in text format, applying no compensation to the one of the pixel data.

14. An image compensation method, comprising:
(a). receiving an image data, the image data having a plurality of consecutive frames and each frame having a plurality of pixel data;
(b). comparing gray-scale values of the pixel data of the consecutive frames of the image data to determine whether to perform image spatial compensation and image timing compensation on the image data;
(c). if determination to perform image spatial compensation:
(c1). determining whether one of the pixel data being in text format according to an ambient color quantity data adjacent to the one of the pixel data;
(c2). if in text format, performing no image spatial compensation; and
(c3). if not in text format, determining how to perform image spatial compensation to the one of the pixel data according to a threshold value and an edge eigenvalue of the one of the pixel data; and
(d). performing timing compensation on the pixel data.

15. The image compensation method of claim 14, wherein the step (c1) comprises:
determining the one of the pixel data as being in text format if the ambient color quantity data is not greater than a preset value.

16. The image compensation method of claim 14, wherein the step (c3) comprises:
calculating the edge eigenvalue of the one of the pixel data;
setting a compensation coefficient according to the edge eigenvalue;
determining whether the compensation coefficient being greater than the threshold value;
if the compensation coefficient being greater than the threshold value, performing no compensation on the one of the pixel data to avoid edge effect;
if the compensation coefficient being not greater than the threshold value, fine tuning the compensation coefficient; and
performing image spatial compensation to the one of the pixel data according to the fine-tuned compensation coefficient.
